(19) United States
(12) Patent Application Publication
(10) Pub. No.: US 2002/0151331 A1
(43) Pub. Date: Oct. 17, 2002

(54) Cryo-cooled front-end system with multiple outputs

(76) Inventors: Amr Abdelmonem, Arlington Heights, IL (US); Benjamin Golant, Crystal Lake, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 09/824,494

(22) Filed: Apr. 2, 2001

(51) Int. Cl. H04B 1/16

(52) U.S. Cl. 455/561

(57) ABSTRACT

A front-end system for receiving signals such as RF signals in a mobile radio communication network includes a cooled vessel such as a cryostat. The cooled vessel includes a manifold that is coupled to the antenna, which separates the various signals received from the antenna. The system includes filters for each signal where such filters are located inside the cooled vessel and may be superconducting. The system may include amplifiers, each of which filters a separate signal from the manifold or may include an amplifier which amplifies the signals before they reach the manifold. The system may also include a wide-band filter which filters the signals prior to amplification or coupling to the manifold.

### FIELD OF THE INVENTION

The present invention relates generally to radio frequency (RF) communication systems and, more particularly, receive front-ends for communication stations, such as a base station for a mobile radio communication network.

### BACKGROUND OF THE INVENTION

Radio frequency (RF) filters have been used with cellular base stations and other telecommunications equipment for some time. Such filters are conventionally used in a receive front-end to filter out noise and other unwanted signals that would harm components of the receiver in the base station. For example, bandpass filters are conventionally used to filter out or block RF signals in all but one or more predefined bands. With the recent dramatic rise in wireless communications, such filtering should provide high degrees of both selectivity (the ability to distinguish between signals separated by small frequency differences) and sensitivity (the ability to receive weak signals) in an increasingly hostile frequency spectrum.

The relatively recent advancements in superconducting technology have given rise to a new type of RF filter, namely, the high-temperature superconducting (HTS) filter. HTS filters contain components which are superconductors at or above the liquid nitrogen temperature of 77K. Such filters provide greatly enhanced performance in terms of both sensitivity and selectivity as compared to a conventional filter. HTS components have been utilized in bandpass filters disposed in the receive path of a cellular base station to realize high degrees of selectivity while maintaining extremely low losses.

Many front-end systems in the cellular and PCS (personal communication systems) industries utilize the same antenna for signals of a number of different transmission formats. This shared antenna practice has proliferated as wireless communication systems have progressed from generation to generation. For example, a single antenna may receive signals within a wide band servicing both a CDMA (code-division multiple access) architecture, as well as an analog scheme, such as AMPS. Furthermore, the CDMA architecture may also constitute multiple CDMA channels, each of which having particular transmission characteristics. For instance, within a typical A band cellular frequency allocation, the received signal from the antenna may contain any combination of up to eight 1.25 MHz CDMA channels. Alternatively, the signal from the antenna of the same A band frequency allocation may contain one or more high speed data CDMA channels and a number of lower speed digital voice channels. In general, the different constituent signals that make up the antenna signal may vary to a great extent, particularly when the transmission formats differ markedly or when the data requirements (phase and/or amplitude linearity) between channel or channel groups vary greatly. The case of different transmission formats being served by the same receive antenna is becoming more prevalent as wireless communication service providers migrate from first generation analog (1G) to digital systems (2G) and beyond (2.5G and 3G systems).

Antennas servicing more than one receiver have often been connected to a receive multi-coupler that delivers each constituent signal within the wide band to a respective receiver or receive path. Each receiver then processes the respective signal in accordance with the applicable technology or generation standard. Multi-couplers have extracted constituent signals utilizing a variety of techniques, such as modifying the transmission line characteristics of the coupling between an interconnection point and a respective filter dedicated to the band or channel of the constituent signal, and thereby a particular receiver or receive path. In this manner, destructive interference for the undesired frequencies may provide isolation on a path-by-path basis to reduce the power losses associated with coupling the wide-band signal received by the antenna to multiple receive paths.

However, as the number of active communication schemes has proliferated (for each base station), and as the nature of the information communicated has been dramatically broadened to include various forms of data, as well as voice, the complexity of a front-end including a receive multi-coupler may accordingly become unwieldy. The number of sectors per base station has also increased the complexity of such front-ends. Such complexities are further increased in the event that HTS components are utilized to maintain low-loss receive paths upstream of any amplification.

Prior base station designs have avoided such complexity by simply electing not to perform any multi-coupling at the RF stage directly following the antenna. Channel or in-band selection is therefore left for subsequent stages. In such systems, the RF stage is limited to wide-band selection, which may be more easily realized using HTS components, inasmuch as the number of filters to be cooled and input/output connections for the cooling system are minimized. As a result, prior cryo-cooled front-ends have only included an RF filter and low-noise amplifier for processing all of the signals received by one antenna in the same way, regardless of the technologies or transmission standards utilized by the receiver(s) downstream (e.g., AMPS, GSM, TDMA, CDMA, GPRS, EDGE, WCDMA, etc.). This approach presents a wider bandwidth of signals than necessary to the downstream receivers, increasing the likelihood of interference and noise, thereby reducing the sensitivity and useable dynamic range of these receivers. Such effects will limit the coverage range of these receivers, and for the case of receivers utilizing CDMA technology, such degradation will also limit the useable channel capacity.

### SUMMARY OF THE INVENTION

In accordance with one aspect of the present invention, a front-end system for receiving a first signal and a second signal via an antenna includes a cooled vessel and a manifold disposed in the cooled vessel, where the manifold is coupled to the antenna. A first filter is coupled to the manifold, disposed in the cooled vessel and configured to pass the first signal. A second filter is coupled to the manifold, disposed in the cooled vessel and configured to pass the second signal. The cooled vessel comprises a first output and a second output for the first signal and the second signal respectively.

The cooled vessel may comprise a cryostat and the first filter and the second filter may include a high-temperature superconducting material.

The manifold includes a first transmission line and a second transmission having respective length such that the first filter is isolated from the second signal, and the second filter is isolated from the first signal. The first signal may be associated with a first channel and the second signal may be associated with a second channel, where the first and second channels differ in at least one of center frequency and bandwidth. The first signal may be associated with the first channel and the second signal associated with the second channel, where the first and second channels have differing data requirements. The first signal may be associated with a voice channel, and the second signal may be associated with a data channel. The first signal and the second signal may be representative of information in accordance with different wireless transmission standards. For instance, the first signal may be representative of information stored in an analog transmission format, and the second signal may be representative of information stored in a digital transmission format.

The system may include a first low-noise amplifier and a second low-noise amplifier coupled to the first and second filters respectively, where the first and second low-noise amplifiers are disposed in the cooled vessel. The system may also include a wide-band filter coupling the manifold to the antenna where the wide-band filter is disposed in the cooled vessel. A low-noise amplifier may couple the wide-band filter to the manifold and be disposed in the cooled vessel.

The system may include first and second cables where the first cable couples the first RF filter to the first output of the cooled vessel, and the second cable couples the second RF filter to the second output of the cooled vessel. The first and second cables may include a mechanism to reduce heat transfer via the first and second outputs. Such a mechanism may include making the first and second cables with excess length.

The system may comprise a second manifold where the second manifold may be outside the cryostat or inside the cryostat.

In accordance with another embodiment of the present invention, a front-end system for receiving a first signal and a second signal via an antenna may include a cooled vessel having a first output and a second output. A wide-band filter configured to pass the first and second signals is coupled to the antenna and disposed in a cooled vessel. A low-noise amplifier is coupled to the wide-band filter. A first bandpass filter is configured to pass the first signal, is coupled to the low-noise amplifier, is disposed in the cooled vessel, and coupled to the first output. A second bandpass filter is configured to pass the second signal, is coupled to the low-noise amplifier, is disposed in the cooled vessel, and is coupled to the second output.

Other features and advantages are inherent in the apparatus claimed and disclosed or will become apparent to those skilled in the art from the following detailed description in conjunction with the accompanying drawings.

### BRIEF DESCRIPTION OF THE DRAWINGS

FIG. 1 is a block diagram of a front-end system in accordance with one embodiment of the present invention; and

FIG. 2 is a block diagram of another front-end system in accordance with an alternative embodiment of the present invention.

### DETAILED DESCRIPTION OF PREFERRED EMBODIMENTS

The present invention is generally directed to a receive front-end system that provides low-loss filtering in conjunction with band- or channel-specific multi-coupling for a wide-band antenna signal that includes a number of constituent signals. The constituent signals are extracted from the wide-band signal utilizing one or more cooled components to maintain low insertion losses for the front-end system. Practice of at least one aspect of the present invention provides low-loss selection for each constituent signal via cooled components despite the number of output connections necessary for delivering each constituent signal from the front-end system to the receiver(s).

The present invention may, but need not, be incorporated into a wireless communication station, such as a base station for a cellular, PCS (personal communication systems), or other wireless system. While particularly useful in a base station context, the present invention may be applied in a variety of communication systems to realize low-loss reception in a multiple output signal configuration.

The following description will set forth the invention in a single-sector context for purposes of clarity only. As will be readily apparent to those skilled in the art, the invention may be applied in a system having one or more additional antennas for coverage of a multiple-sector cell. In such cases, the front-end system of the present invention may incorporate the teachings of U.S. Pat. No. 5,828,944, entitled “Diversity Reception Signal Processing System,” the disclosure of which is hereby incorporated by reference.

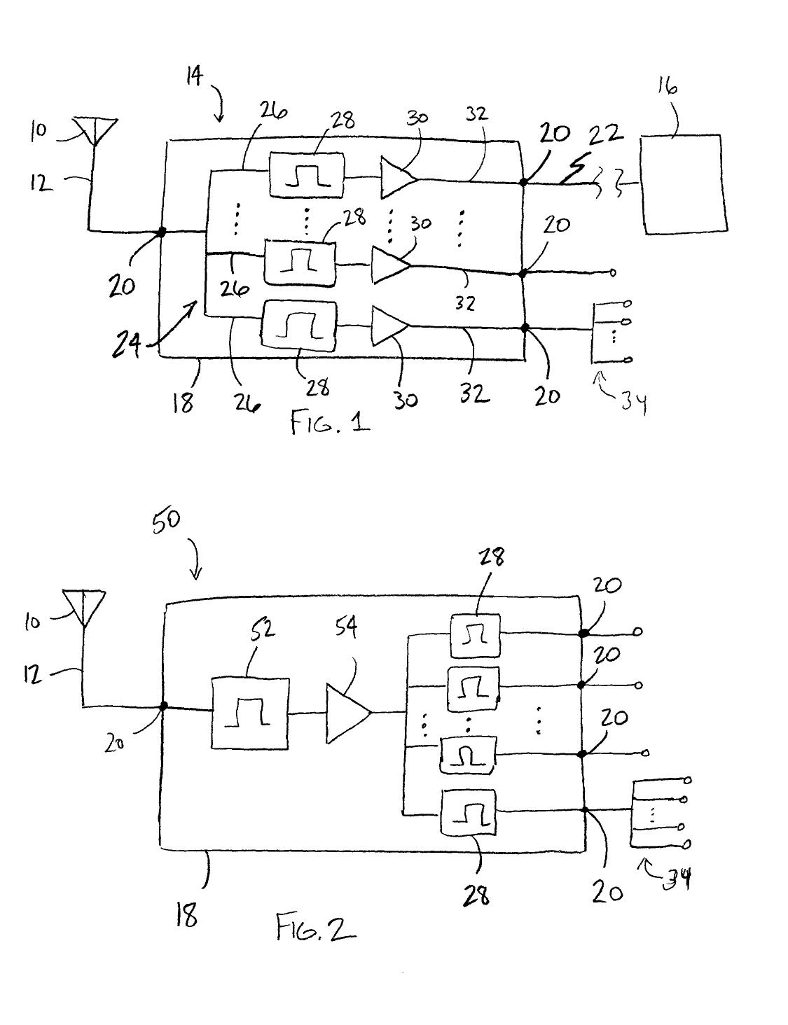

With reference to FIG. 1, an antenna 10, the particular structure of which is not pertinent to the practice of the present invention, provides an antenna signal on a transmission line 12 to a front-end indicated generally at 14. The antenna signal collected by the antenna 10 is actually a composite signal having a number of constituent signals representative of respective information. For instance, the constituent signals may be representative of voice information, data, and the like. The constituent signals are processed by the front-end 14 in preparation for further processing by one or more receivers 16 that translate one or more of the constituent signals from the RF domain to an intermediate or IF stage, as well as to stages suitable for digital signal processing of the received information.

The transmission line 12 may constitute any coaxial or other cabling suitable for RF signals in the frequency bands utilized for wireless communication. The material and structure of the cabling is selected in the interest of minimizing losses through matching impedances and minimizing the length of the cable, as well as in accordance with other considerations known to those skilled in the art.

As will be described in further detail herein below, the front-end 14 includes high-performance components that operate in a cooled environment maintained by a cooling system (not shown) that may include or, alternatively, support a cooled vessel 18. The cooled vessel 18 is preferably a cryostat that houses and, therefore, cools the cryogenic components of the front-end 14. More generally, the cooling system is preferably a cryo-cooler or cryo-refrigerator The cryostat may, for example, be constructed in accordance with the teachings of commonly assigned U.S. patent application Ser. No. 08/831,175, the disclosure of which is hereby incorporated by reference. Generally speaking, however, cryo-refrigeration that maximizes heat lift while drawing a minimum amount of power is preferred for use with the present invention. At present, Stirling-cycle coolers shown to draw 200 Watts or less are preferred for use in connection with the present invention. As will be described hereinafter, such highly efficient cooling machines are utilized to address the significant head load brought about by multi-coupling in the front-end 14, which accordingly leads to multiple output connections, each presenting the system with additional heat load.

The cooled vessel 18 has multiple input/output ports or connections 20 that couple the cryogenic components to ambient components disposed outside of the cryostat. Ambient components include cabling 22 leading from the front-end 14 to the remainder of the base station or receiver 16. The specific details of the manner in which the front-end is coupled to the remainder of the base station are well known in the art and, except as noted herein, not relevant to the practice of the present invention.

The input/output ports 20 serve as a thermal interface between the cryogenic and ambient environments and, as is known in the art, may effect significant heat loss through the utilization of thermal conductive cabling. Accordingly, one aspect of the present invention is directed to minimizing the heat load provided by the input/output connections 20, particularly in light of the increased number of outputs required by the multiple receive paths brought about by the multi-coupling of the present invention.

In accordance with one embodiment of the present invention, and continued reference to FIG. 1, the front-end 14 includes a plurality of receive paths that include RF elements that process either the composite antenna signal or the constituent signals extracted therefrom. The processing occurs in a cooled environment (i.e., in the cooled vessel 18) such that very low insertion losses are realized thereby. More particularly, the front-end 14 includes a manifold indicated generally at 24 having a plurality of coupling lines 26 coupled to the input/output connection 20 leading to the antenna 10. The manifold 24 feeds a plurality of receive paths with a portion (i.e., a particular constituent signal) of the composite signal collected by the antenna 10. As a result, the number of receive paths is commensurate with the number of constituent signals contained in the composite signal.

Each coupling line 26 is designed to couple a respective constituent signal in an efficient manner to a respective RF bandpass filter 28, which is tuned to a center frequency and passband commensurate with the respective constituent signal. Generally speaking, the manifold 24 and coupling lines 26 are structured to provide a low-loss multi-coupling arrangement. More particularly, each coupling line 26 preferably constitutes a transmission line and/or coupling mechanism to a respective filter 28 that isolates the receive path in question from the other constituent signals distributed by the manifold 24. In this manner, minimal power losses occur as a result of the distribution of the composite signal amongst the respective receive paths. In one embodiment, each coupling line 26 consists of a certain length of cable that changes the input impedance of the respective filter 28 for frequencies other than the passband of the filter. Such an approach to multi-coupling is well-known and will not be further described herein. Other embodiments provide the necessary impedance modification via the input coupling for the initial stage of the filter 28, as is also well known to those skilled in the art.

Once each constituent signal has been extracted from the composite signal, each constituent signal is amplified by a respective low-noise amplifier (LNA) 30 that sets the noise figure for the respective receive path. The amplified signal provided by the LNA 30 is, in turn, provided to one of the output ports 20 via cabling 32.

The processing of each constituent signal as set forth above provides a way for the base station to optimize receiver sensitivity for each type of technology, transmission format, channel type, etc. Each processed signal path provides an input to the subsequent receivers that has been optimized with respect to bandwidth and gain. This minimizes the likelihood of interference which reduces the sensitivity or useable dynamic range of these receivers, and instead maximizes the coverage and/or capacity performance of these receivers. To this end, the front-end 14 provides a filtered signal via the output ports 20 to the receiver(s) 16 using the minimum bandwidth required. The front-end 14 may also provide a filtered signal that may allow the convenient integration of standard next generation receivers, as service providers migrate their systems to offer new data and multi-media features.

In accordance with one embodiment of the present invention, the cabling 32 includes extra or added length to decrease the heat load provided by each input/output connection 20 for each receive path. Adding length to the cabling 32 increases the thermal resistance in that cabling, thereby minimizes heating of components in the cryostat. Alternatively, or in addition, the cabling 32 has a structure or material designed to lower or minimize thermal conduction. Certain of such structures or materials are shown in U.S. Pat. Nos. 5,856,768 and 6,207,901, the disclosures of which are hereby incorporated by reference. In addition, in some types of filters, magnetic coupling schemes can be used to couple signals between filters and cabling which connects outside the cryostat. Such magnetic coupling will not require the conductors in the cabling to physically contact the components in the cryostat, thereby providing a measure of thermal isolation. A lower thermal conductivity material or structure may lead to higher losses, but such losses would occur downstream of the LNA 30 and, therefore, be relatively insignificant. For a three sectored site with receiver diversity, the addition of each separate filtered path in the front-end 14 adds 6 additional output lines. If the heat load for these additional cables is not managed for minimum heat loss, the capacity of the cooler may become inadequate to maintain an optimum operating temperature and performance of the system is degraded. Even if the capacity of the cooler remains adequate for maintaining an optimum operating temperature, the increase in heat load will degrade the cooldown time associated with the this equipment.

The constituent signals may constitute either analog or digital transmission signals, and/or multiple channels of a particular technology, such as CDMA. As shown in FIG. 1, the manifold 24 may feed any number of receive paths. Furthermore, the receive paths may have the same or different bandwidths or center frequencies. In one embodiment, a receive path may includes multiple channels distributed over the entire bandwidth of its corresponding filter 28. In such cases, downstream of the filter 28 and amplifier 30, further multi-coupling is provided via an additional manifold 34, which may be inside or outside the cryostat 18.

FIG. 2 shows an alternative front-end indicated generally at 50. Elements common to one or more figures are identified with like reference numerals. The front-end 50 differs from the embodiment shown in FIG. 1 in that wide-band filtering or selection occurs prior to any multi-coupling or distribution of the constituent signals. In this manner, a wide-band RF filter 52 is coupled to the antenna 10 and an LNA 54 sets the noise figure for the entire wide band, irrespective of any particular requirements for a certain channel, etc. While certain gain adjustments may need to occur downstream of the front-end 50 for this reason, the front-end 50 need only include a single LNA in the cooled vessel 18. This trade-off may lead to lower heat load as well as a lower cost front-end.

The bandpass filters 28 (as well as the filter 52) are disposed in the cryostat 64 such that any losses introduced thereby are minimal or low. Each filter 28 or 52 may, but need not, include a high-temperature superconducting (HTS) material in the interest of maintaining extremely low losses despite high amounts of rejection. In general, such HTS bandpass filters are available from, for example, Illinois Superconductor Corporation (Mt. Prospect, Ill.). More particularly, each filter 28 or 52 may constitute an all-temperature, dual-mode filter constructed in accordance with the teachings of commonly assigned U.S. patent application Ser. No. 09/158,631, the disclosure of which is hereby incorporated by reference. While incorporating HTS technology to minimize low losses, the dual-mode filter remains operational at an acceptable filtering level despite a failure in the cooling system. Alternatively, each filter 28 includes bypass technology as set forth in the aforementioned U.S. Pat. No. 6,104,934 or in commonly assigned U.S. patent application Ser. No. 09/552,295, the disclosures of which is hereby incorporated by reference. It should be noted, however, that any necessary phase-adjustment for blocking transmit signals may need to be addressed in a bypass path as well.

Each filter 28 or 52 may alternatively constitute a filter system having two or more cascaded filters in accordance with the teachings of commonly assigned U.S. patent application Ser. No. 09/130,274, the disclosure of which is hereby incorporated by reference. Such cascaded filter arrangements may provide extremely high levels of rejection without the difficulties associated with tuning a single highly selective filter.

Each filter 28 or 52 may utilize either thick or thin film technology or a hybrid of both. In the event that HTS materials are utilized, a thick film resonant structure may be constructed in accordance with the teachings of U.S. Pat. No. 5,789,347, the disclosure of which is hereby incorporated by reference.

With regard to the LNAs 30, examples of a suitable LNA are set forth in the above-referenced U.S. patents and patent applications.

Although certain instantiations of the teachings of the invention have been described herein, the scope of coverage of this patent is not limited thereto. On the contrary, this patent covers all instantiations of the teachings of the invention fairly falling within the scope of the appended claims either literally or under the doctrine of equivalents.

What is claimed is:

1. A front-end system for receiving a first signal and a second signal via an antenna, comprising:
a cooled vessel;
a manifold disposed in the cooled vessel and coupled to the antenna;
a first filter coupled to the manifold, disposed in the cooled vessel, and configured to pass the first signal; and
a second filter coupled to the manifold, disposed in the cooled vessel, and configured to pass the second signal;
wherein the cooled vessel comprises a first output and a second output for the first signal and the second signal, respectively.

2. The front-end system of claim 1 wherein the cooled vessel comprises a cryostat.

3. The front-end system of claim 1 wherein the first filter and the second filter comprise a high-temperature superconducting material.

4. The front-end system of claim 1 wherein the manifold comprises a first transmission line and a second transmission line having respective lengths such that the first filter is isolated from the second signal and the second filter is isolated from the first signal.

5. The front-end system of claim 1 wherein:
the first signal is associated with a first channel and the second signal is associated with a second channel; and
the first channel and the second channel differ in at least one of center frequency and bandwidth.

6. The front-end system of claim 1 wherein:
the first signal is associated with a first channel and the second signal is associated with a second channel; and
the first channel and the second channel have differing data requirements.

7. The front-end system of claim 1 wherein the first signal is associated with a voice channel and the second signal is associated with a data channel.

8. The front-end system of claim 1 wherein the first signal and the second signal are representative of information in accordance with different wireless transmission standards.

9. The front-end system of claim 1 wherein the first signal is representative of information stored in an analog transmission format and the second signal is representative of information stored in a digital transmission format.

10. The front-end system of claim 1, further comprising a first low-noise amplifier and a second low-noise amplifier coupled to the first filter and the second filter, respectively, wherein the first and second low-noise amplifiers are disposed in the cooled vessel.

11. The front-end system of claim 1, further comprising a wide-band filter coupling the manifold to the antenna wherein the wide-band filter is disposed in the cooled vessel.

12. The front-end system of claim 11, further comprising a low-noise amplifier coupling the wide-band filter to the manifold wherein the low-noise amplifier is disposed in the cooled vessel.

13. The front-end system of claim 1 further comprising a first cable and a second cable wherein:
the first cable couples the first RF filter to the first output of the cooled vessel;
the second cable couples the second RF filter to the second output of the cooled vessel; and
the first and second cables comprise a mechanism to reduce heat transfer via the first and second outputs.

14. The front-end system of claim 13 wherein the first and second cables comprise excess length.

15. The front-end system of claim 1 comprising a second manifold.

16. The front-end system of claim 15 wherein the second manifold is outside the cryostat.

17. The front-end system of claim 15 wherein the second manifold is inside the cryostat.

18. A front-end system for receiving a first signal and a second signal via an antenna, comprising:
a cooled vessel having a first output and a second output;
a wide-band filter configured to pass the first and second signals, coupled to the antenna, and disposed in the cooled vessel;
a low-noise amplifier coupled to the wide-band filter;
a first bandpass filter configured to pass the first signal, coupled to the low-noise amplifier, disposed in the cooled vessel, and coupled to the first output; and
a second bandpass filter configured to pass the second signal, coupled to the low-noise amplifier, disposed in the cooled vessel, and coupled to the second output.

19. The front-end system of claim 18 wherein the cooled vessel comprises a cryostat.

20. The front-end system of claim 18 wherein the first bandpass filter and the second bandpass filter comprise a high-temperature superconducting material.

21. The front-end system of claim 18 further comprising a manifold that couples the low-noise amplifier to the first and second bandpass filters.

22. The front-end system of claim 21 wherein the manifold comprises a first transmission line and a second transmission line having respective lengths such that the first bandpass filter is isolated from the second signal and the second bandpass filter is isolated from the first signal.

23. The front-end system of claim 18 wherein:
the first signal is associated with a first channel and the second signal is associated with a second channel; and
the first channel and the second channel differ in at least one of center frequency and bandwidth.

24. The front-end system of claim 18 wherein:
the first signal is associated with a first channel and the second signal is associated with a second channel; and
the first channel and the second channel have differing data requirements.

25. The front-end system of claim 18 wherein the first signal is associated with a voice channel and the second signal is associated with a data channel.

26. The front-end system of claim 18 wherein the first signal and the second signal are representative of information in accordance with different wireless transmission standards.

27. The front-end system of claim 18 wherein the first signal is representative of information stored in an analog transmission format and the second signal is representative of information stored in a digital transmission format.

28. The front-end system of claim 18 further comprising a first cable and a second cable wherein:
the first cable couples the first bandpass filter to the first output of the cooled vessel;
the second cable couples the second bandpass filter to the second output of the cooled vessel; and
the first and second cables comprise a mechanism to reduce heat transfer via the first and second outputs.

29. The front-end system of claim 28 wherein the first and second cables comprise excess length.

30. The front-end system of claim 18 comprising a second manifold.

31. The front-end system of claim 30 wherein the second manifold is outside the cryostat.

32. The front-end system of claim 30 wherein the second manifold is inside the cryostat.
